(19) United States
(12) Patent Application Publication
(10) Pub. No.: US 2010/0174391 A1
(43) Pub. Date: Jul. 8, 2010

(54) Remote Control System and Relay Unit

(75) Inventors: Akihiko SUYAMA, Hamamatsu-shi (JP); Masatoshi Kawashima, Hamamatsu-shi (JP)

Correspondence Address: CROWELL & MORING LLP;INTELLECTUAL PROPERTY GROUP, P.O. BOX 14300, WASHINGTON, DC, 20044-4300, US

(73) Assignee: Yamaha Corporation, Hamamatsu-shi (JP)

(21) Appl. No.: 12/652,943

(22) Filed: Jan. 6, 2010

(30) Foreign Application Priority Data
Jan. 7, 2009 (JP) 2009-001968

(51) Int. Cl. G06F 17/00; G05B 11/01

(52) U.S. Cl. 700/94; 700/14

(57) ABSTRACT

A remote control system includes a commander, a device to be controlled, and a relay unit. The commander transmits a start command and an end command, and a continuation command at intervals of first specific time after transmission of the start command until the end command is transmitted. The relay unit includes a control unit that causes a control signal transmission unit to start transmitting the control signal in response to receipt of the start command and that causes the control signal transmission unit to stop transmitting the control signal in response to receipt of the end command. The control unit causes the control signal transmission unit to stop transmitting the control signal when the next command is not received even after elapse of a second specific time since the command is received, the second specific time being longer than the first specific time.

### BACKGROUND OF THE INVENTION

1. Technical Field

The present invention relates to a remote control system in which a commander controls a device to be controlled via a relay unit.

2. Background Art

Many pieces of audio equipment are remotely controllable by means of an infrared remote control code. A recently-proposed audio system is equipped with a relay unit that transmits an infrared remote control code to audio equipment, that has a wireless LAN function, and that is disposed in the vicinity of the audio equipment, and that controls the audio equipment by a commander having a wireless LAN function.

When audio equipment is remotely controlled in connection with; for instance, turning up/down of the volume, fast forward/fast rewind of a content to be played back, and the like, a remote control code is continually transmitted for a predetermined period of time, thereby turning up or down the volume or fast forwarding or rewinding a content to a desired extent.

Meanwhile, since wireless LAN communication is effected by means of a protocol, such as a TCP/IP, difficulty is encountered in continually performing processing for a period of time, such as continual transmission of a remote control code. Therefore, a commander sends a communication to a relay unit in the form of a start command being transmitted at the start of continual transmission of a remote control code and an end command being transmitted at the end of continual transmission of the remote control code. The relay unit performs control operation of starting continual transmission of the remote control code upon receipt of the start command and completing continual transmission of the remote control code upon receipt of the end command (see, for example, JP-T-2003-511901).

However, when the relay unit becomes unable to receive an end command for reasons of any communication failure after receipt of a start command, the aforementioned communication pattern raises a problem of continual transmission of the remote control code being continued without interruption. For instance, when an end command cannot be received in the course of continual transmission of a remote control code for turning up the volume, the audio equipment will be commanded to turn up the volume endlessly, so that the volume is turned up uncontrollably.

### SUMMARY OF THE INVENTION

The present invention aims at providing a remote control system that can prevent a system from running out of control even when an end command cannot be received.

According to an aspect of the present invention, there is provided a remote control system in which a commander controls a device to be controlled via a relay unit, wherein the commander includes a command transmission unit that transmits commands including a start command for commanding initiation of control of the device and an end command for commanding completion of control of the device, and a continuation command for commanding continuation of control of the device at intervals of first specific time after transmission of the start command until the end command is transmitted, the relay unit includes: a control signal transmission unit that transmits a control signal to the device; a command receiving unit that receives the commands; and a control unit that causes the control signal transmission unit to start transmitting the control signal in response to receipt of the start command and that causes the control signal transmission unit to stop transmitting the control signal in response to receipt of the end command, wherein the control unit monitors an interval at which the command is received and causes the control signal transmission unit to stop transmitting the control signal when the next command is not received even after elapse of a second specific time since the command is received, the second specific time being longer than the first specific time.

The remote control system may be configured in that the command transmission unit is adapted to transmit the commands to the relay unit via a wireless LAN, and the control signal transmission unit is adapted to transmit the control signal in a form of an infrared remote control code to the device.

The remote control system may be configured in that the commander includes an operation section; and the command transmission unit transmits the start command when the operation section is operated and transmits the end command when operation of the operation section is canceled.

The remote control system may be configured in that the device to be controlled is an audio and video player.

The remote control system may be configured in that the operation section includes a volume up/down operator.

The remote control system may be configured in that the operation section includes a fast-forward/fast-rewind operator.

According to another aspect of the present invention, there is provided a relay unit for relaying signals transmitted from a commander to a device to be controlled, the relay unit comprising: a control signal transmission unit that transmits a control signal to the device; a command receiving unit that receives commands including a start command for commanding initiation of control of the device and an end command for commanding completion of control of the device, and a continuation command for commanding continuation of control of the device that is transmitted between the start command and the end command; and a control unit that causes the control signal transmission unit to start transmitting the control signal in response to receipt of the start command and that causes the control signal transmission unit to stop transmitting the control signal in response to receipt of the end command, wherein the control unit monitors an interval at which the command is received and causes the control signal transmission unit to stop transmitting the control signal when the next command is not received even after elapse of a specific time since the command is received.

According to still another aspect of the present invention, there is provided a remote control system in which a commander controls a device to be controlled, wherein the commander includes a command transmission unit that transmits commands for controlling a specific operation in the device, the commands including a start command for commanding initiation of control of the specific operation, an end command for commanding completion of control of the specific operation, and a continuation command for commanding continuation of control of the device at intervals of first specific time after transmission of the start command until the end command is transmitted; the device includes: a command receiving unit that receives the commands; and a control unit that control to start the specific operation in the device in response to receipt of the start command, and to stop the specific operation in the device in response to receipt of the end command, wherein the control unit monitors an interval at which the command is received and stops controlling the specific operation when the next command is not received even after elapse of a second specific time since the command has been received, the second specific time being longer than the first specific time.

According to aspects of the present invention, even when receipt of an end command has ended in failure, transmission of a control signal will be stopped if the next command is not received even after elapse of a specific period of time. Therefore, it is possible to prevent a system from running out of control, such as uncontrollable raising of the volume. Since a continuation command is transmitted at specific periods of time, even when; for instance, a volume UP key is pressed for a long period of time, it is possible to effect control commensurate with the period of time during which the key is pressed.

### BRIEF DESCRIPTION OF THE DRAWINGS

In the accompanying drawings:

FIG. 1 is a block diagram of an audio system according an embodiment of the present invention;

FIGS. 2A and 2B are timing charts showing transmission of a volume control command in the audio system;

FIG. 3 is a flowchart showing operation of a commander of the audio system; and

FIG. 4 is a flowchart showing operation of a player of the audio system.

### DETAILED DESCRIPTION OF THE PREFERRED EMBODIMENTS

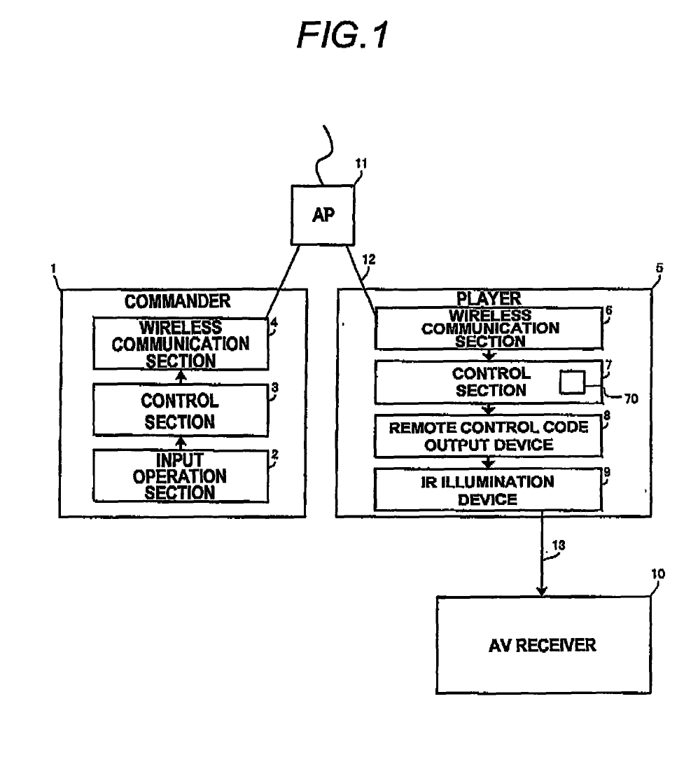

FIG. 1 is a block diagram of an audio system according to an embodiment of the present invention. The audio system includes a commander 1 that is a device for transmitting a command message via a wireless LAN 12; a player 5 that has, as a relay unit, a function of receiving a command message from the commander 1 and outputting a remote control code corresponding to the command message by means of an infrared ray, and an AV receiver 10 serving as a device to be controlled that receives light of an infrared remote control code and that performs operation corresponding to the remote control code.

The commander 1 includes a user interface and transmits a command message conforming to user's operation to the wireless LAN 12. The player 5 has a function of a wireless LAN that plays back contents produced by a plurality of pieces of source equipment. The AV receiver 10 has a function of a power amplifier that amplifies a content played back by the player 5 and emits the thus-amplified content from a speaker.

The commander 1 includes an input operation section 2, a control section 3, and a wireless communication section 4. The input operation section 2 has a liquid-crystal display, a touch pad, key switches, and the like. The touch pad is a device for moving a cursor over the display and selecting an object pointed with the cursor. The user can move the cursor by touching the object with a fingertip and moving the object. The object pointed with the cursor can be selected by lightly tapping the object with the fingertip. The key switches include; for instance, volume UP and DOWN keys, play and stop keys, fast forward and fast rewind keys, and the like.

The volume UP and DOWN keys are key switches for adjusting an amplification gain of the AV receiver 10, to thus raise or lower the playback volume of a content. The fast forward and fast rewind key are key switches for fast forwarding or rewinding a playback position of a content. Any of volume UP and DOWN operations and fast forward and fast rewind operations are controlled in such a way that a device to be controlled performs the operation while a corresponding key switch is pressed.

The control section 3 includes a CPU and memory that stores a plurality of command messages and outputs a command message responsive to operation of the input operation section 2 performed by the user. For instance, when the user presses a volume UP key, the control section 3 detects pressing of the volume UP key, simultaneously outputting a “volume UP start” command message. Upon detection of release of the volume UP key from a pressed state, the control section 3 simultaneously output s a “volume UP complete” command message. The wireless communication section 4 is a circuit section that has a wireless LAN communication function of infrastructure mode requiring involving use of the access point 11 and transmits the command message output by the control section 3 to the wireless communication section 6 of the player 5 via the wireless LAN 12.

The player 5 includes the wireless communication section 6, a control section 7, a remote control code output device 8, and an infrared LED 9 that is an IR light-emitting device. The wireless communication section 6 has a wireless LAN communication function of infrastructure mode involving use of the access point 11 and receives the command message transmitted by the commander 1 via the wireless LAN 12. The control section 7 interprets the command message received by the wireless communication section 6 and commands the remote control code output device 8 to output a remote control code corresponding to specifics of the command message. The remote control code output device 8 outputs a remote control code corresponding to the command from the control section 7, thereby driving and causing the LED 9 to illuminate by means of a code pattern of the remote control code. Upon receipt of; for instance, a volume UP start command, the remote control code output device repeatedly outputs a volume UP remote control code, thereby causing the LED 9 to continually illuminate. Upon receipt of a volume UP end command, the remote control code output device 8 causes the LED to stop continual illumination.

The AV receiver 10 receives light of the remote control code that has been output by the LED 9 by means of infrared radiation 13. In accordance with specifics of the received remote control code, the AV receiver 10 controls its own operation. When received light of for instance, a volume UP remote control code, the AV receiver raises a playback volume by increasing the gain of the amplifier. When a volume UP remote control code is continually received, an increase rate of gain is accelerated, to thus immediately raise the volume. When the volume UP remote control code is not received, an increase in gain is stopped.

Transmission of a remote control code from the player 5 to the AV receiver 10 is one-way transmission effected by the infrared radiation 13 as mentioned above. Therefore, continual pressing of a key switch (e.g., a volume UP key) can be expressed by causing the LED 9 to continually illuminate through use of a remote control code.

Meanwhile, transmission of the command message from the commander 1 to the player 5 is carried out in conformance with a network communication protocol, such as a TCP/IP, involving use of a wireless LAN 12. The network communication protocol is a method according to which one end transmits a message and the other end returns an acknowledgement (ACK) message to the effect of receipt of a message upon receipt of the message. Therefore, it is impossible to express continual pressing of a key switch by continually sending a message.

Therefore, the commander 1 adopts a method according to which the commander transmits a start command during press operation (at a start of process) and transmits an end command at the time of release of a key from a pressed state (at an end of process) in connection with the key switches to be continually actuated, such as the volume UP key, the volume DOWN key, the fast forward key, and the fast rewind key.

The player 5 causes the LED 9 to start continually illuminating by means of a remote control code corresponding to the start command upon receipt of the start command and to stop continual illumination upon receipt of the end command. Continual illumination means repeated driving of the LED 9 performed by means of a code pattern of the same remote control code.

The player 5 has a monitor timer 70 that automatically stops continual illumination even when failed to receive the end command transmitted by the commander 1. A case where receipt of a command message is impossible corresponds to; for instance, a case where communication is interrupted as a result of any faults having occurred in a wireless LAN network, and the like; specifically, a case where a radio wave is disturbed by high frequency noise originating from a microwave oven, or the like. The monitor timer 70 is provided in the control section 7 in the form of software. Upon receipt of a command message (a start command) from the commander 1, the control section 7 of the player 5 activates the monitor timer 70. When the monitor timer 70 indicates a predetermined time T2 (e.g., six seconds), continual illumination is stopped even if the end command is not received.

Since there is also a case where a key switch is continually pressed for a long period of time in excess of the time T2, the commander 1 transmits a continuation command at a time interval T1 (e.g., five seconds) that is shorter than the time T2) when the key switches is kept being pressed. Upon receipt of the continuation command, the player 5 resets the monitor timer 70 and re-starts clocking of the time T2 from the beginning.

Thus, occurrence of erroneous operation (e.g., endless raising of the volume, and the like), which would otherwise be caused by a failure to receive the end command, can be prevented. Even when a key switch is continually pressed for a long period of time, control commensurate with a duration of pressed state can be performed.

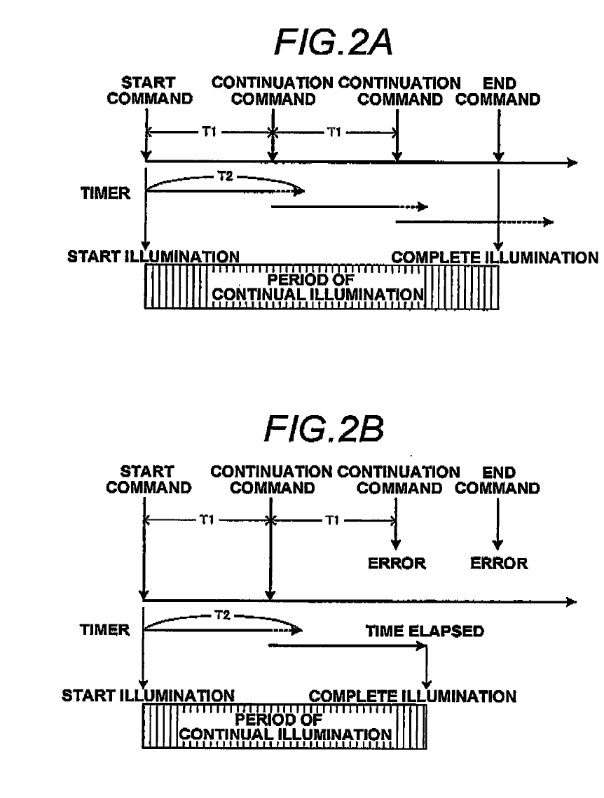

FIGS. 2A and 2B are timing charts showing command message transmission timing and remote control code transmission timing of a single audio system.

FIG. 2A is a timing chart for normal times when network communication is not interrupted.

First, when the user presses a predetermined key switch; for instance, a volume UP key or a fast forward key, the commander 1 transmits a start command for commanding initiation of illumination of a remote control code corresponding to the key switch.

Upon receipt of the start command, the player 5 simultaneously causes the monitor timer 70 to start, as well as causing the LED 9 to start continually illuminating by means of the commanded remote control code.

During a period in which the key switch is kept being pressed, the commander 1 transmits a continuation command at every cycle of time T1. When the key switch is released from a pressed state, an end command is transmitted.

Upon receipt of a command message from the commander 1 before the monitor timer 70 indicates the time T2, the player 5 carries out operation conforming to the message. Specifically, the command message is a continuation command, the player resets the monitor timer 70, to thus continue continual illumination. When the command message is an end command, continual illumination is stopped, and the monitor timer 70 is stopped, as well.

FIG. 2B is a timing chart for the case of an anomaly in which network communication is interrupted.

When the user presses a predetermined key switch as in the case of FIG. 2A, the commander 1 transmits a command for initiating illumination of a remote control code corresponding to the key switch. During a period in which the key switch is kept being pressed, the commander 1 transmits the continuation command every T1. When the key switch is released from a pressed state, the end command is transmitted.

Upon receipt of the start command, the player 5 simultaneously causes the LED 9 to start continual illumination by means of a commanded remote control code and causes the monitor timer 70 to start. Subsequently, when network communication is interrupted because of any faults and when the monitor timer 70 indicates the time T2 without receipt of the next command, communication is determined to be anomalous, and continual illumination is stopped.

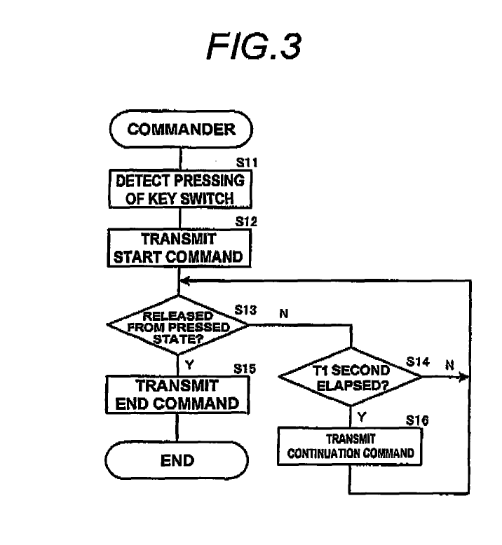

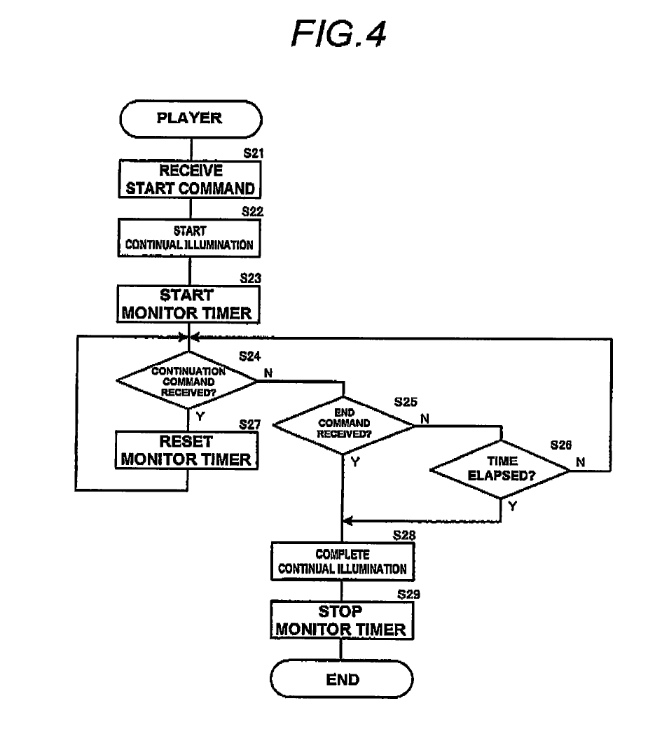

Command message transmission processing of the commander 1 and remote control code output processing of the player 5 are described by reference to flowcharts shown in FIGS. 3 and 4.

FIG. 3 is a flowchart showing command message transmission processing operation of the commander 1.

First, when pressing of a predetermined key switch performed by the user is detected (S11), a start command for commanding initiation of illumination of a remote control code corresponding to the key switch is output (S12). Subsequently, the commander awaits in S13 and S14 until release of the key switch from a pressed state (S13) or elapse of the time T1 (S14) is detected. When release of the key switch from a pressed state is detected (YES in S13), an end command for commanding completion of illumination is output (S15), whereupon operation is completed. Meanwhile, when the time T1 has elapsed while the key switch is pressed (YES in S14), a continuation command is output (S16), and the commander returns to a standby routine pertaining to S13 and S14.

FIG. 4 is a flowchart showing remote control code output processing operation of the player 5.

First, when a start command is received form the commander 1 (S21), the remote control code output device 8 is caused to output a remote control code commanded by the start command, thereby causing the LED 9 to start illumination (S22). Simultaneously, the monitor timer 70 is caused to start (S23), and the player awaits in a standby routine pertaining to S24 to S26 until receipt of a continuation command (S24), receipt of an end command (S25), or completion of the time assigned to the monitor timer 70 (S26) is detected.

When a continuation command is received from the commander 1 (YES in S24), the monitor timer 70 is reset, and the commander returns to a standby routine pertaining to S24 to S26. Upon receipt of the end command from the commander 1 (YES in S25), continual illumination of the LED is completed (S28), and the monitor timer 70 is halted (S29), whereby processing is completed. Meanwhile, when the monitor timer 70 indicates time for complete (YES in S26), continual illumination of the LED is likewise completed (S28), and the monitor timer 70 is halted (S29). Thus, processing is completed.

The present invention is applied to outputting of a command message and a remote control code assigned to key switches to be continually pressed, such as the volume UP key switch, the volume DOWN key switch, the fast forward key switch, and the fast rewind key switch. In the case of a key switch, which performs one processing operation in response to one pressing action, like a power button, even if the key is continually pressed, a command message is transmitted once in response to one pressing action, and the remote control code is illuminated only once.

In the present embodiment, a wireless communication section that makes a wireless LAN communication is provided as a command transmission unit. An infrared LED and a remote control code output device that continually illuminates an infrared LED by means of a remote control code are used as a control signal transmission unit. A command transmission unit and a control signal transmission unit are not limited to the device. For instance, the control signal transmission unit may also be wired.

Although the present embodiment has been described by means of taking an example audio system as an example of the wireless remote control system, the present invention is not limited to the audio system.

The audio system of the present embodiment includes the commander 1, the player 5 serving as a relay unit, and the AV receiver 10 serving as a device to be controlled. Communication is established between the commander 1 and the player 5 by means of the wireless LAN, and communication is established between the player 5 and the AV receiver 10 by means of infrared radiation. Alternatively, the audio system may also include the commander 1 and the player 5 which serves as a device to be controlled, and the player 5 may also be configured so as to be controlled in relation to raising or lowering of the volume via the wireless LAN 12. In this case, when the next command cannot be received even after elapse of the time T2, the player 5 forcefully completes control operation, such as raising of the volume.

Moreover, timing at which the commander transmits a start command and an end command is not limited to timing at which pressing of a key switch is started and at which a key switch is released from a pressed state. For instance, the commander may also transmit a start command or an end command at predetermined timing regardless of user's operation by means of any program or sequence.

In the present embodiment, the commander 1 transmits command messages to the player 5 via the access point 11 by way of wireless LAN 12 in the infrastructure mode. Alternatively, the commander 5 directly transmits command messages to the player 6 in AdHoc mode without using the access point 11.

What is claimed is:

1. A remote control system in which a commander controls a device to be controlled via a relay unit, wherein
the commander includes a command transmission unit that transmits commands including a start command for commanding initiation of control of the device and an end command for commanding completion of control of the device, and a continuation command for commanding continuation of control of the device at intervals of first specific time after transmission of the start command until the end command is transmitted,
the relay unit includes:
a control signal transmission unit that transmits a control signal to the device;
a command receiving unit that receives the commands; and
a control unit that causes the control signal transmission unit to start transmitting the control signal in response to receipt of the start command and that causes the control signal transmission unit to stop transmitting the control signal in response to receipt of the end command,
wherein the control unit monitors an interval at which the command is received and causes the control signal transmission unit to stop transmitting the control signal when the next command is not received even after elapse of a second specific time since the command is received, the second specific time being longer than the first specific time.

2. The remote control system according to claim 1, wherein
the command transmission unit is adapted to transmit the commands to the relay unit via a wireless LAN, and
the control signal transmission unit is adapted to transmit the control signal in a form of an infrared remote control code to the device.

3. The remote control system according to claim 1, wherein
the commander includes an operation section; and
the command transmission unit transmits the start command when the operation section is operated and transmits the end command when operation of the operation section is canceled.

4. The remote control system according to claim 3, wherein the device to be controlled is an audio and video player.

5. The remote control system according to claim 4, wherein the operation section includes a volume up/down operator.

6. The remote control system according to claim 4, wherein the operation section includes a fast-forward/fast-rewind operator.

7. A relay unit for relaying signals transmitted from a commander to a device to be controlled, the relay unit comprising:
a control signal transmission unit that transmits a control signal to the device;
a command receiving unit that receives commands including a start command for commanding initiation of control of the device and an end command for commanding completion of control of the device, and a continuation command for commanding continuation of control of the device that is transmitted between the start command and the end command; and
a control unit that causes the control signal transmission unit to start transmitting the control signal in response to receipt of the start command and that causes the control signal transmission unit to stop transmitting the control signal in response to receipt of the end command,
wherein the control unit monitors an interval at which the command is received and causes the control signal transmission unit to stop transmitting the control signal when the next command is not received even after elapse of a specific time since the command is received.

8. A remote control system in which a commander controls a device to be controlled, wherein
the commander includes a command transmission unit that transmits commands for controlling a specific operation in the device, the commands including a start command for commanding initiation of control of the specific operation, an end command for commanding completion of control of the specific operation, and a continuation command for commanding continuation of control of the device at intervals of first specific time after transmission of the start command until the end command is transmitted;
the device includes:
a command receiving unit that receives the commands; and
a control unit that control to start the specific operation in the device in response to receipt of the start command, and to stop the specific operation in the device in response to receipt of the end command,
wherein the control unit monitors an interval at which the command is received and stops controlling the specific operation when the next command is not received even after elapse of a second specific time since the command has been received, the second specific time being longer than the first specific time.
